(19) United States
(12) Patent Application Publication
(10) Pub. No.: US 2012/0136603 A1
(43) Pub. Date: May 31, 2012

(54) TEST APPARATUS AND DEBUG METHOD

(75) Inventors: Shinichi ISHIKAWA, Saitama (JP); Tetsu KATAGIRI, Saitama (JP); Masaru GOISHI, Saitama (JP); Hiroyasu NAKAYAMA, Saitama (JP); Masaru TSUTO, Saitama (JP)

(73) Assignee: ADVANTEST CORPORATION, Tokyo (JP)

(21) Appl. No.: 13/118,586

(22) Filed: May 31, 2011

Related U.S. Application Data
(63) Continuation of application No. PCT/JP2009/002404, filed on May 29, 2009.
Application No. PCT/JP2009/002404 is a continuation-in-part of application No. 12/329,635, filed on Dec. 8, 2008, now Pat. No. 8,059,547.

(51) Int. Cl. G06F 19/00

(52) U.S. Cl. 702/85; 702/122

(57) ABSTRACT

A test apparatus that tests a device under test by communicating with the device under test using packets that each include one or more command sequences, comprising a transmitting/receiving section that transmits and receives the packets to and from the device under test based on packet sequence information designating an order in which the packets are transmitted and received between the device under test and each pin of the test apparatus, and a display section that displays information indicating the packets transmitted and received between the device under test and each pin of the test apparatus, arranged in time sequence. The display section displays information of each packet transmitted or received in parallel on a time axis set in common for each pin of the test apparatus. Each packet includes identification information identifying a packet type, and the display section displays information including the identification information of each packet.

### BACKGROUND

1. Technical Field

The present invention relates to a test apparatus and a debug method.

2. Related Art

A test apparatus for testing a semiconductor device, for example, judges pass/fail of the device under test by inputting a test signal having a prescribed pattern to the device under test and measuring a signal output by the device under test in response to the test signal. A test apparatus that tests a device under test using a prescribed pattern is described in Japanese Patent Application Publication No. 2006-058251, for example.

An increase in the circuit size of the device under test causes the pattern for the test signal to become more complicated. In particular, when testing a device under test that has a function for transmitting and receiving data in packets, the test apparatus must perform a data handshake with the device under test. Furthermore, the test apparatus must transmit a wait packet and prepare the next transmission while waiting for a response from the device under test during the handshake, in order to be able to respond quickly.

Accordingly, when testing a device that has a function for transmitting and receiving data in packets, a complicated test pattern must be input to the test apparatus. Furthermore, the test pattern is a data sequence including values of 0 and 1, and therefore it is difficult to determine whether the test pattern has been correctly transmitted or received during the handshake.

### SUMMARY

Therefore, it is an object of an aspect of the innovations herein to provide a test apparatus and a debug method, which are capable of overcoming the above drawbacks accompanying the related art. The above and other objects can be achieved by combinations described in the independent claims. According to a first aspect related to the innovations herein, provided is a test apparatus that tests a device under test by communicating with the device under test using packets that each include one or more command sequences, the test apparatus comprising a transmitting/receiving section that transmits and receives the packets to and from the device under test based on packet sequence information designating an order in which the packets are transmitted and received between the device under test and each pin of the test apparatus; and a display section that displays information indicating the packets transmitted and received between the device under test and each pin of the test apparatus, arranged in time sequence.

According to a second aspect related to the innovations herein, provided is a test apparatus in which the display section displays information of each packet transmitted or received in parallel on a time axis set in common for each pin of the test apparatus.

According to a third aspect related to the innovations herein, provided is a test apparatus in which each packet includes identification information identifying a type of the packet, and the display section displays information including the identification information of each packet.

According to a fourth aspect related to the innovations herein, provided is a test apparatus further comprising a detecting section that detects the identification information of each packet transmitted to or received from the device under test, in which the display section displays information including the identification information detected by the detecting section.

According to a fifth aspect related to the innovations herein, provided is a test apparatus in which the display section displays the packets with different appearances, according to the type of the packet.

According to a sixth aspect related to the innovations herein, provided is a test apparatus further comprising a comparing section that compares a data value of a predetermined one of the packets received from the device under test to a predetermined expected value, in which the display section displays the packets with different appearances, according to a result of the comparison by the comparing section.

According to a seventh aspect related to the innovations herein, provided is a test apparatus in which the display section displays source code of the packet sequence information together with information indicating the packets transmitted or received according to the packet sequence information.

According to an eighth aspect related to the innovations herein, provided is a test apparatus in which further comprising an editing section that designates a location in the source code of the packet sequence information displayed by the display section and, when editing information for changing content of the location is received, changes the content of the location in the source code of the packet sequence information.

According to a ninth aspect related to the innovations herein, provided is a test apparatus further comprising a packet designating section that, when designation information is received designating a piece of information from among the pieces of information indicating the packets displayed by the display section, displays in the display section the source code of the packet corresponding to the designation information.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary configuration of a test apparatus 10 according to an embodiment of the present invention.

FIG. 2 shows an exemplary relationship between packets, packet lists, procedures, and a test program.

FIG. 3 shows an exemplary procedure in which a packet list is recorded.

FIG. 4 shows an exemplary command sequence for generating a wait packet and an exemplary data sequence included in the wait packet.

FIG. 5 shows an exemplary command sequence for generating a write packet and an exemplary data sequence included in the write packet.

FIG. 6 shows an exemplary screen displayed by the display section 106.

FIG. 7 shows a configuration of a test apparatus 10 according to another embodiment.

FIG. 8 shows an exemplary display of data and the source code of a packet function when a write packet is designated.

FIG. 9A shows exemplary source code of a procedure according to another embodiment.

FIG. 9B shows exemplary source code of a procedure according to another embodiment.

FIG. 10 shows an exemplary configuration of the execution processing section 11.

FIG. 11 shows an exemplary configuration of the transmission-side block 12.

FIG. 12 shows an exemplary configuration of the reception-side block 14.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

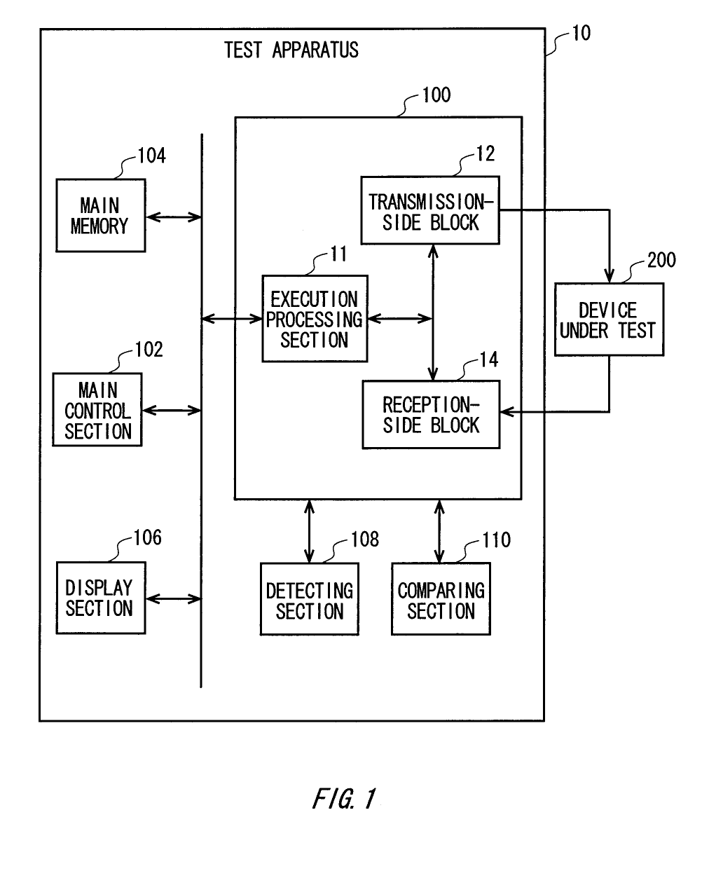

FIG. 1 shows an exemplary configuration of a test apparatus 10 according to an embodiment of the present invention. The test apparatus 10 tests a device under test 200 by communicating with the device under test 200 using packets that each include one or more command sequences. The test apparatus 10 includes a transmitting/receiving section 100, a main control section 102, a main memory 104, a display section 106, a detecting section 108, and a comparing section 110.

The transmitting/receiving section 100 transmits and receives packets to and from the device under test 200, based on a procedure in which is recorded packet sequence information (referred to hereinafter as “packet lists”) designating an order in which the packets are to be transmitted between the device under test 200 and each pin of the test apparatus 10. More specifically, the transmitting/receiving section 100 transmits and receives packets to and from the device under test 200 by executing a test program that includes a series of one or more procedures. The transmitting/receiving section 100 may store the test program in a recording medium, such as a non-volatile memory.

The test apparatus 10 may transmit to and receive from the device under test 200 various types of packets including write packets (Write) having a function for writing data to the device under test 200, read packets (Read) having a function for reading data from the device under test 200, and test packets (Test) having a function for inputting test data to the device under test 200. The test apparatus 10 may transmit to the device under test 200 a wait packet that includes information indicating an idle state during which functions are not performed, when not transmitting packets for executing the functions described above.

The test apparatus 10 may include a plurality of pins, and each pin may be connected to a plurality of different pins of the device under test 200. The test apparatus 10 and the device under test 200 may transmit and receive serial communication data in a USB or IEEE 1394 format, for example, via the pins. The transmitting/receiving section 100 may sequentially transmit and receive packets among a plurality of pins of the device under test 200, according to the packet lists recorded in the procedures.

The transmitting/receiving section 100 includes an execution processing section 11, a transmission-side block 12, and a reception-side block 14. The execution processing section 11 executes a test program including one or more procedures in series. The transmission-side block 12 is controlled by the execution processing section 11 to transmit packets to an input pin of the device under test 200. More specifically, the transmission-side block 12 assembles the packets designated by the packet list recorded in the procedure executed by the execution processing section 11 into a prescribed format, and then transmits the packets to the device under test 200.

The reception-side block 14 receives packets output by an output pin of the device under test 200. The reception-side block 14 may input to the execution processing section 11, as a variable value, a data value included in the packet received from the device under test 200.

The main control section 102 controls operation of the test apparatus 10. For example, the main control section 102 may instruct the transmitting/receiving section 100 to begin transmitting and receiving packets. The main memory 104 stores the data included in the packets transmitted by the transmitting/receiving section 100 and the data included in the packets received by the transmitting/receiving section 100.

The display section 106 displays information indicating the packets transmitted between the device under test 200 and each pin of the test apparatus 10, in time sequence. The information indicating the packets may be information identifying the packet type, source code corresponding to the packet, and a data value included in the packet, for example. The display section 106 may display information corresponding to packets that are actually transmitted to or received from the device under test 200 by the transmitting/receiving section 100. As another example, the display section 106 may display information corresponding to hypothetical packets transmitted or received by the transmitting/receiving section 100 acquired via a simulation.

The display section 106 displays information concerning the transmitted and received packets in parallel along a time axis that is set to be common for each pin of the test apparatus 10. For example, if the test apparatus 10 includes reception pins RX0 and RX1 and a transmission pin TX0, the display section 106 may arrange display regions corresponding to RX0, RX1, and TX0 in a horizontal direction on the display screen. The display section 106 may display each piece of information indicating a packet transmitted or received by a pin in a vertical direction within the display region of the corresponding pin, in an order according to the time of the transmission or reception.

The transmitting/receiving section 100 transmits and receives packets that include identification information for identifying the type of packet being transmitted or received. For example, the transmitting/receiving section 100 may attach packet information indicating whether the packet being transmitted or received is a write packet, a read packet, a test packet, or a wait packet.

The detecting section 108 is connected to the transmitting/receiving section 100. The detecting section 108 detects the identification information of packets transmitted between the transmitting/receiving section 100 and the device under test 200. The detecting section 108 detects the identification information of packets transmitted by the transmission-side block 12 to the device under test 200 and the identification information of packets received by the reception-side block 14 from the device under test 200. The detecting section 108 may detect the identification information of the packets by acquiring the packet list from the execution processing section 11. For example, the detecting section 108 may detect the packet function name in the packet list as the identification information of the packet.

The detecting section 108 inputs the detected identification information into the display section 106. The display section 106 displays information that includes the identification information detected by the detecting section 108. The display section 106 may display each packet using a different appearance, according to the type of packet. For example, the display section 106 may display each packet using a color or pattern that corresponds to the packet type.

The comparing section 110 compares a data value of a prescribed packet received from the device under test 200 to an expected value. The comparing section 110 may be supplied with the packet received by the reception-side block 14, and compare the data included in this packet to an expected value acquired from the execution processing section 11. The comparing section 110 inputs the comparison result to the display section 106. The comparing section 110 may be included in the reception-side block 14.

The display section 106 may display the packets using different appearances, according to the comparison results of the comparing section 110. For example, the display section 106 may use different colors or patterns to display a case in which the data included in the packet received by the reception-side block 14 matches the expected value and a case in which the data included in the packet received by the reception-side block 14 does not match the expected value.

Furthermore, the display section 106 may display a source code of the procedure along with information indicating the packets transmitted and received according to the packet list. The source code of the procedure is a code in which are recorded packet functions corresponding to the types of packets being transmitted and received. The display section 106 may include a plurality of windows in the display screen. The display section 106 may simultaneously display information indicating the data included in the packets transmitted or received by the transmitting/receiving section 100 in a first window and the source code of the procedure in a second window.

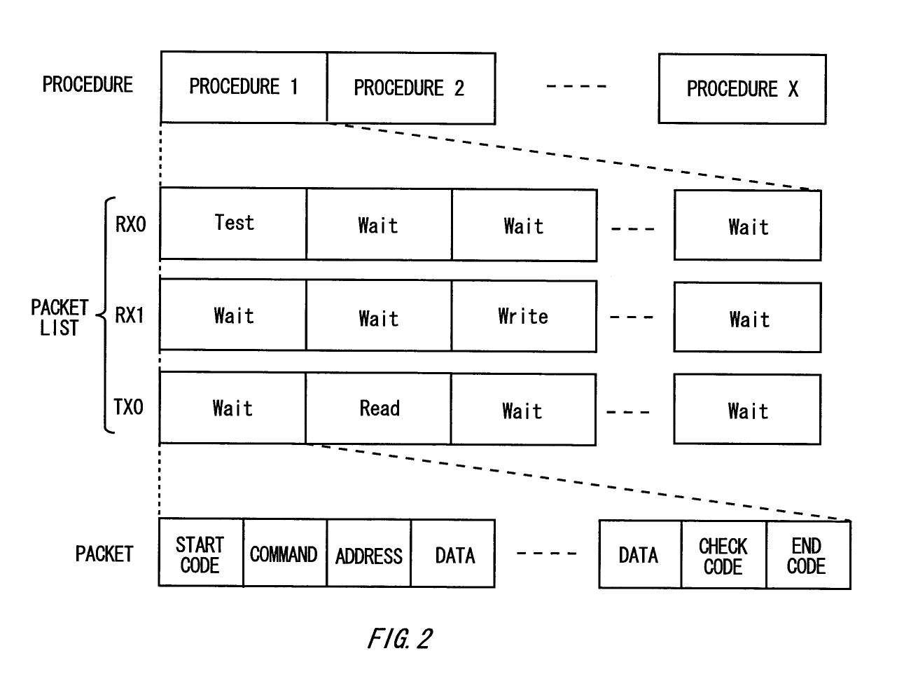

FIG. 2 shows an exemplary relationship between packets, packet lists, procedures, and a test program. The test program executed by the test apparatus 10 includes one or more procedures. Each procedure includes information specifying packet lists that indicate the order in which packets are to be transmitted to and received from the device under test 200.

For example, Procedure 1 in FIG. 2 includes information that specifies packet lists for transmitting or receiving packets to and from the pins RX0, RX1, and TX0. Each packet list corresponding to a pin includes a plurality of different types of packets, such as test packets (Test), write packets (Write), read packets (Read), and wait packets (Wait), for example.

In the example of FIG. 2, the transmitting/receiving section 100 first transmits a test packet from the pin RX0. While the test packet is being transmitted from RX0, the transmitting/receiving section 100 transmits wait packets from the other pins. When the transmission of the test packet from RX0 is finished, the transmitting/receiving section 100 transmits a read packet from TX0 to read the data at an address designated by information in the read packet. Next, the transmitting/receiving section 100 transmits a write packet from the pin RX1, to write data in an address region in the device under test 200 designated by information in the write packet. The transmitting/receiving section 100 may write the data read from TX0 via the pin RX1.

Each packet includes a start code and an end code. Furthermore, each packet includes a command indicating the type of the packet. The start code, end code, and command are set for each type of packet. The data region of each packet stores data that is recorded in the source code of the test program.

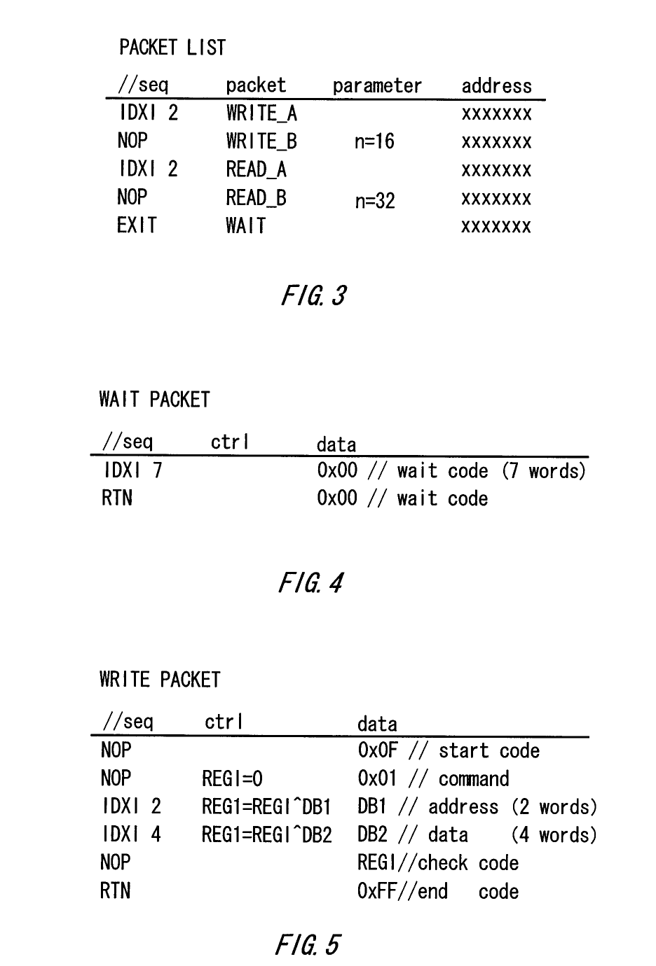

FIG. 3 shows an exemplary procedure in which a packet list is recorded. The transmitting/receiving section 100 executes a test program that includes the procedure shown in FIG. 3. The test program includes a plurality of commands to be executed sequentially, parameters and types of packets recorded in association with each of the commands, and addresses indicating storage locations of data sequences and command sequences for generating the corresponding types of packets.

More specifically, the test program may include NOP commands, IDXI commands, and an EXIT command, for example. Each NOP command generates the packet associated with the NOP command once, and then causes the next command to be executed. Each IDXI command generates the packet associated with the IDXI command a designated number of times, and then causes the next command to be executed. The EXIT command generates the packet associated with the EXIT command once, and then ends the packet list execution. The commands included in the test program are not limited to the above examples, and the test program may include branching commands that cause the next command to be executed to be determined according to whether designated conditions are fulfilled.

The test program may have recorded therein the type of packet for identifying whether a packet is a write packet, a read packet, or a wait packet that repeatedly generates a prescribed code. The test program may include leading addresses at which are stored command sequences for generating the packets, or leading addresses of common data included in the packets and leading addresses of individual data included in the packets.

FIG. 4 shows an exemplary command sequence for generating a wait packet and an exemplary data sequence included in the wait packet. FIG. 5 shows an exemplary command sequence for generating a write packet and an exemplary data sequence included in the write packet.

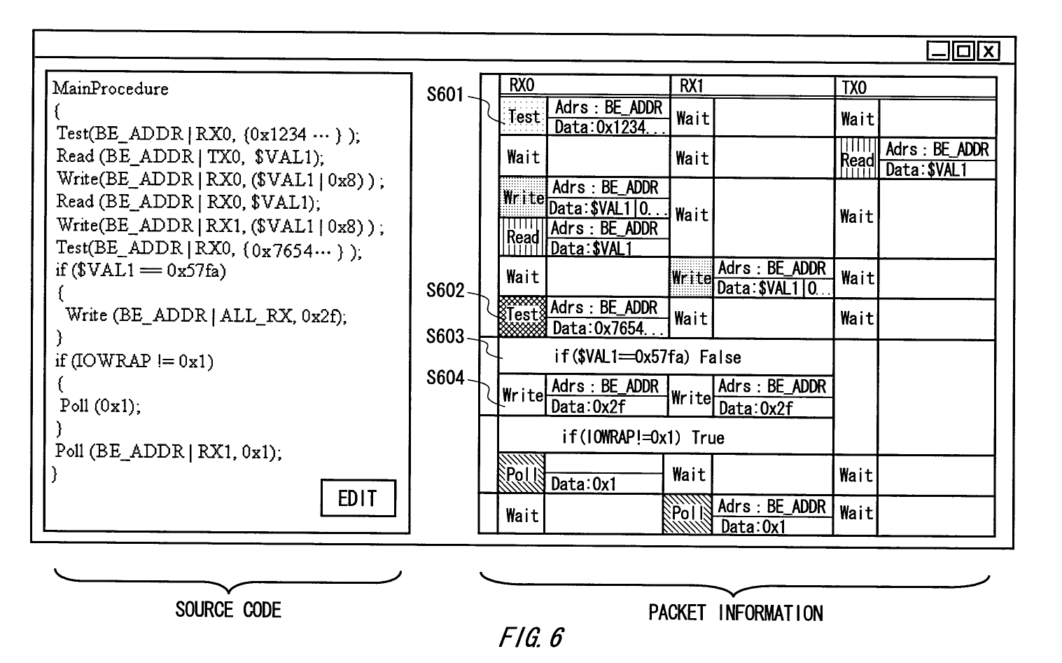

FIG. 6 shows an exemplary screen displayed by the display section 106. The display section 106 displays the source code of the procedure on the left side of the screen. The display section 106 displays information concerning the packet lists corresponding to the source code on the right side of the screen.

The display section 106 displays information relating each packet list transmitted or received by one of the pins RX0, RX1, and TX0. More specifically, the display section 106 displays the packet type and the information included in the packet for each packet, in an order according to the time at which the packet is transmitted or received. For example, for the pin RX0, the display section 106 sequentially displays a test packet, a wait packet, a write packet, and a read packet. The display section 106 may display a different pattern or color for each packet type.

If the data acquired from the device under test 200 after the test packet is transmitted to the device under test 200 differs from the expected value, the display section 106 may display the result with a specified color or pattern. For example, at S601 in FIG. 6, the test apparatus 10 may transmit from RX0 a test packet that includes 0x1234 . . . as a test pattern. Furthermore, at S602, the test apparatus 10 may transmit from RX0 a test packet that includes 0x7654 . . . as a test pattern.

The test apparatus 10 compares the expected value to each response signal received from the device under test 200 after a test packet is transmitted thereto. The display section 106 may display a first appearance when the comparison result indicates a match and display a second appearance when the comparison result indicates a mismatch. In the example of FIG. 6, the comparison result corresponding to the test packet transmitted at S601 indicates a match, and therefore the display section 106 displays a dot pattern. On the other hand, the comparison result corresponding to the test packet transmitted at S602 indicates a mismatch, and therefore the display section 106 displays a criss-cross pattern. The display section 106 may display a green color when the comparison result indicates a match and a red color when the comparison result indicates a mismatch.

The display section 106 can display a specified color or pattern for only packets that are actually transmitted to the device under test 200. For example, when the procedure includes a branching command, a packet function cannot be executed if the packet function is not fulfilled. In FIG. 6, the branching condition at S603 is not fulfilled, and therefore the write packet is not transmitted at S604. Therefore, the write packet at S604 is not displayed with a different appearance.

The names of the pins displayed in the display section 106 may each indicate a group including a plurality of pins. For example, the display RX0 may represent pins relating to a first communication type, such as USB, and the RX1 display may represent pins relating to a second communication type, such as IEEE 1394.

As described above, the test apparatus 10 of the present embodiment tests the device under test 200 by transmitting a plurality of types of packets to the device under test 200 in the order recorded in the test program. Furthermore, the test apparatus 10 displays information relating to the packets that are sent to the device under test 200 and the source code of the procedure. As a result, a user of the test apparatus 10 can easily recognize the content of the test being performed or an error in the test pattern, for example.

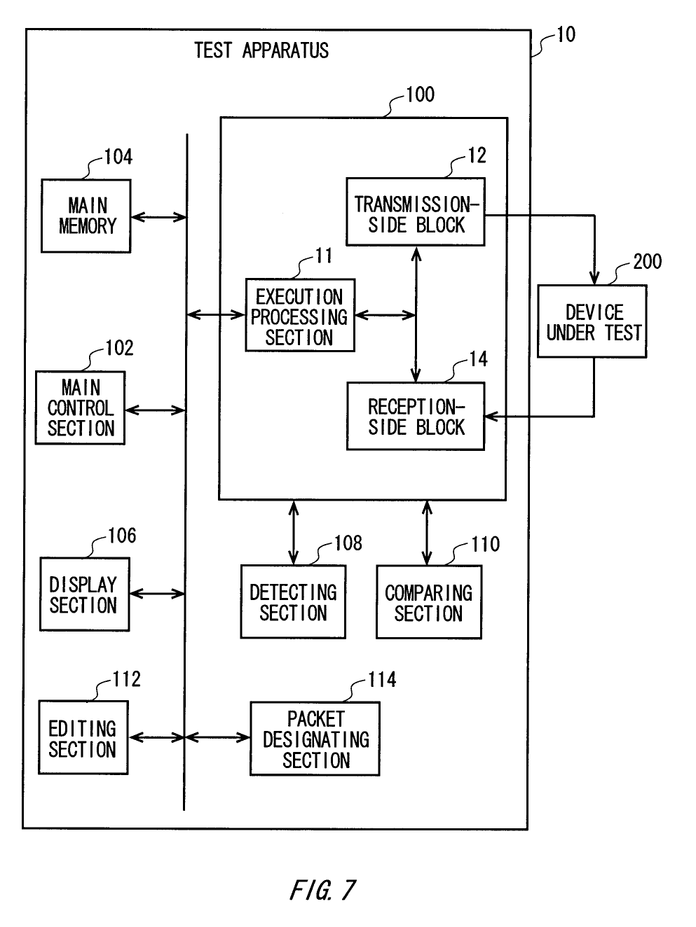

FIG. 7 shows a configuration of a test apparatus 10 according to another embodiment. In FIG. 7, the test apparatus 10 further includes an editing section 112 and a packet designating section 114. The editing section 112 designates a position of a source code of the procedure displayed by the display section 106, and changes the content at this position in the source code of the procedure when editing information for changing the content of this position is received. For example, when the “EDIT” button on the screen shown in FIG. 6 is clicked, the test apparatus 10 enters an edit mode in which the source code can be edited. When the test apparatus 10 enters the edit mode, the display section 106 may change the “EDIT” button display to be “END EDITING” for example.

In the edit mode, the test apparatus 10 may be operated by a user to change data values in the packet functions recorded in the source code. The test apparatus 10 may be operated to add a packet function to the source code, or to delete a packet function. When the “END EDITING” button is clicked, the editing section 112 saves the source code that is currently displayed.

When designation information is received that designates one piece of information among the pieces of information indicating the packets displayed by the display section 106, the packet designating section 114 causes the display section 106 to display the source code of a packet function corresponding to this designation information. When the region displaying the information indicating a packet is clicked, the packet designating section 114 may display the source code of this packet and the data value of the source code in the display section 106.

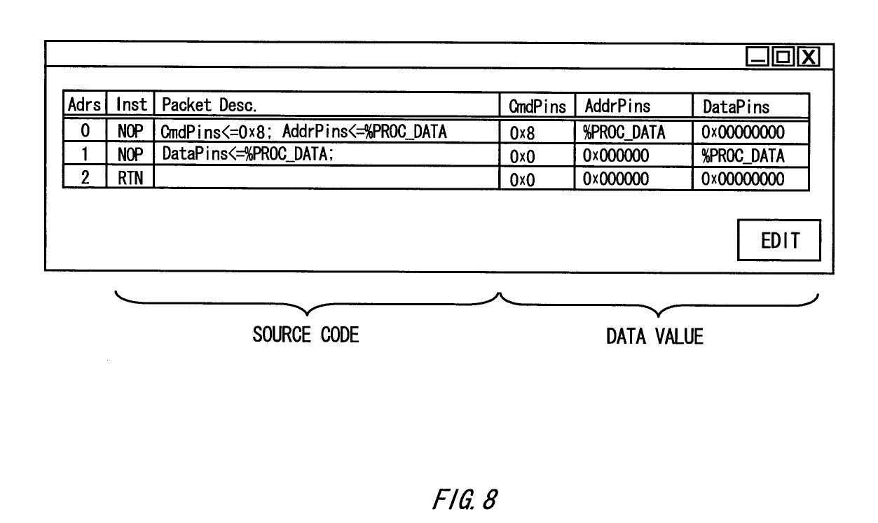

FIG. 8 shows an exemplary display of data and the source code of a packet function when a write packet is designated. The display section 106 displays the “EDIT” button together with the source code and the data values. When information indicating that the “EDIT” button has been clicked is received from the display section 106, the packet designating section 114 causes the display section 106 to enter the edit mode in which the source code and data values can be edited. When the source code is edited, the editing section 112 may change the data value corresponding to the edited source code. When data is edited, the editing section 112 may change the source code corresponding to the edited data. When the “END EDITING” button is clicked, the editing section 112 stores the source code currently displayed.

In the manner described above, the test apparatus 10 of the present embodiment can edit the source code of a displayed packet function and procedure. Accordingly, the user can easily change the pattern of the test signal.

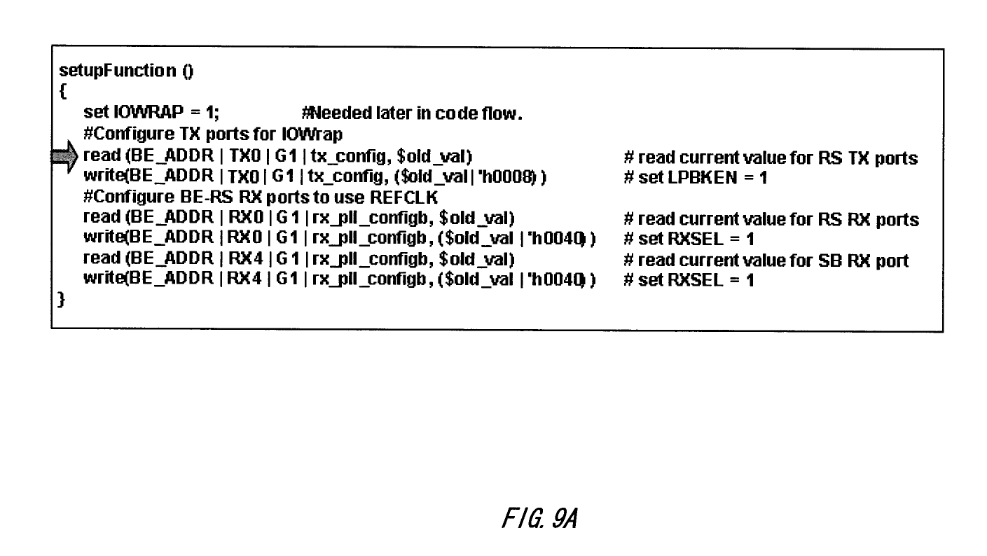

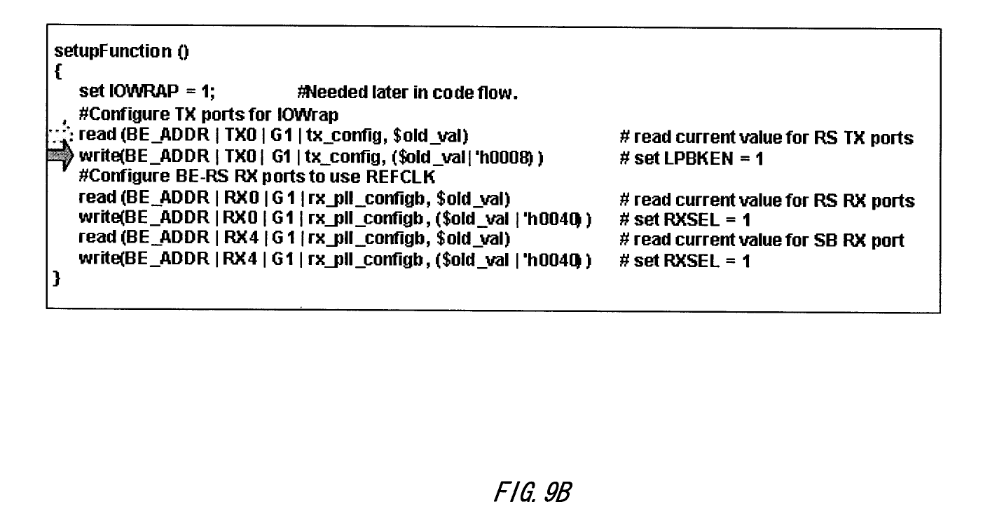

FIGS. 9A and 9B show exemplary source codes of procedures according to other embodiments. The test apparatus 10 may stop the packet function executed by the procedure at a break point designated by the user. The arrow shown in FIG. 9A indicates a state in which the test apparatus 10 has stopped execution of the packet function at a point in time at which a read packet is sent from the pin TX0.

Next, upon receiving step execution instructions from the user, the display section 106 moves the arrow to the position indicating the following packet function in FIG. 9B. At the same time, the transmitting/receiving section 100 executes the packet function at the destination of this movement. In the examples shown in FIGS. 9A and 9B, the packet function at the movement destination is a write packet designating the pin TX0, and therefore the transmitting/receiving section 100 transmits a write packet storing therein a prescribed data value from the pin TX0.

The test apparatus 10 may execute packets designated by the user in series. The test apparatus 10 may execute packets with intervals therebetween designated by the user. In this way, the test apparatus 10 of the present embodiment enables the user to select conditions for executing the packets. Accordingly, the cause of problems occurring during testing of the device under test 200 can be easily identified.

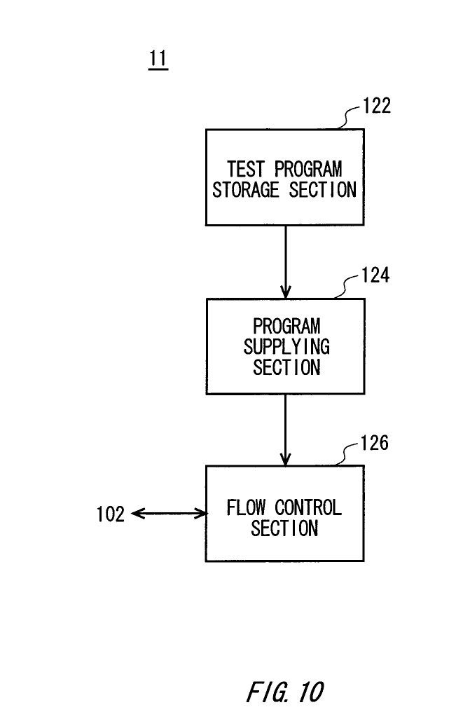

FIG. 10 shows an exemplary configuration of the execution processing section 11. The execution processing section 11 includes a test program storage section 122, a program supplying section 124, and a flow control section 126.

The test program storage section 122 stores the test programs. The test program storage section 122 may acquire the test programs from the main memory 104. The program supplying section 124 extracts a plurality of packet lists from a test program stored in the test program storage section 122, and stores the packet lists in packet list storage sections 20 in the transmission-side block 12 and the reception-side block 14. The program supplying section 124 generates a control program, in which is recorded a control flow for sequentially executing the packet lists extracted from the test program, and supplies the control program to the flow control section 126.

The flow control section 126 designates, for the transmission-side block 12 and the reception-side block 14, the order in which the packet lists are to be executed, according to the execution flow of the test program. More specifically, the flow control section 126 executes the control program received from the program supplying section 124, to identify for the transmission-side block 12 and the reception-side block 14 the next packet list to be executed. For example, the flow control section 126 may transmit to the transmission-side block 12 and the reception-side block 14 an address of the packet list to be executed next.

If the control program includes computations such as conditional branching, unconditional branching, or subroutine acquisition, the flow control section 126 may cause the main control section 102 to execute the control program. The flow control section 126 may identify the packet list to be executed next based on the computation results of the computation by the main control section 102. In this case, the flow control section 126 may wait to identify the next packet list until receiving the computation result from the main control section 102, and select the packet list to identify according to the computation result.

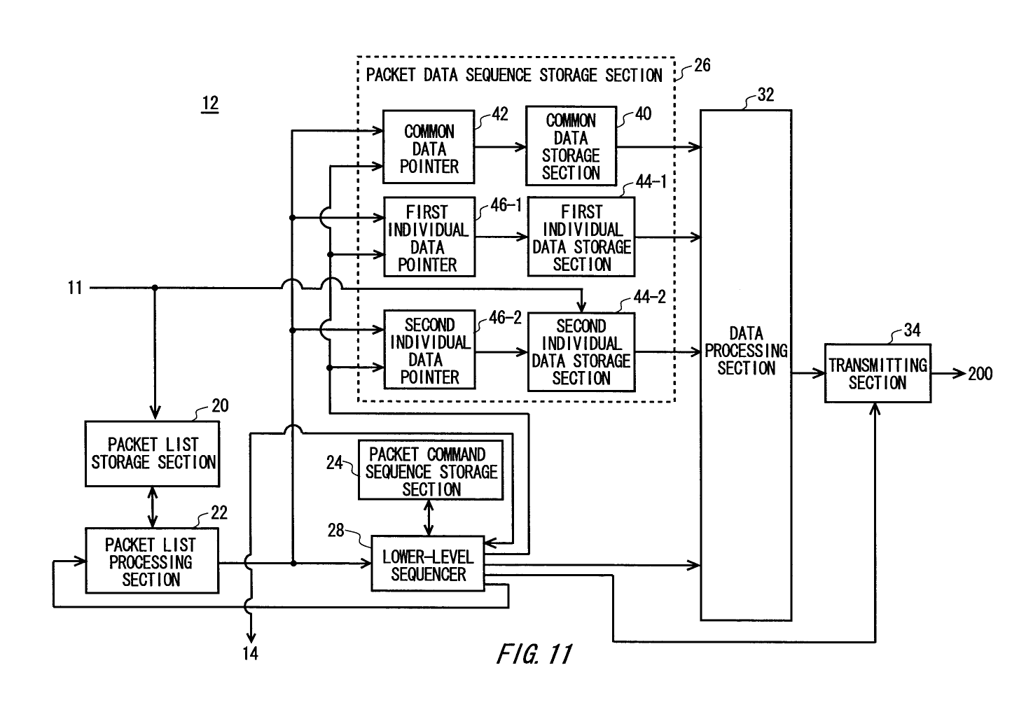

FIG. 11 shows an exemplary configuration of the transmission-side block 12. The transmission-side block 12 includes a packet list storage section 20, a packet list processing section 22, a packet command sequence storage section 24, a packet data sequence storage section 26, a lower-level sequencer 28, a data processing section 32, and a transmitting section 34.

The packet list storage section 20 stores a plurality of packet lists supplied from the program supplying section 124. The packet list processing section 22 executes a packet list based on the address designated by the flow control section 126, from among the packet lists stored in the packet list storage section 20, to sequentially designate the packets to be transmitted to the device under test 200.

The packet list processing section 22 may designate an address, e.g. a leading address, in the packet command sequence storage section 24 of a command sequence for generating the designated packet, fore example, for each packet to be transmitted to the device under test 200. Furthermore, the packet list processing section 22 may designate an address, e.g. a leading address, of a data sequence included in the packet in the packet data sequence storage section 26 to be transmitted to the device under test 200.

In this way, the packet list processing section 22 individually designates an address of a command sequence for generating a packet and an address of a data sequence included in the packet. In this case, if a command sequence or data sequence is designated that is common to two or more packets in the packet list, the packet list processing section 22 may designate the same command sequence address or the same data sequence address for the two or more packets.

The packet command sequence storage section 24 stores, for each type of packet, a command sequence for generating a corresponding type of packets. For example, the packet command sequence storage section 24 may store a command sequence for generating write packets, a command sequence for generating read packets, and a command sequence for generating wait packets.

The packet data sequence storage section 26 stores, for each type of packet, a data sequence included in a corresponding type of packet. For example, the packet data sequence storage section 26 may store a data sequence included in a write packet, a data sequence included in a read packet, and a data sequence included in a wait packet.

The packet data sequence storage section 26 may include a common data storage section 40, a common data pointer 42, a first individual data storage section 44-1, a second individual data storage section 44-2, a first individual data pointer 46-1, and a second individual data pointer 46-2. The common data storage section 40 stores common data that is shared among the packet types, in a data sequence included in each type of packet. The common data storage section 40 may store, for each packet type, a start code indicating the start of the packet, an end code indicating the end of the packet, and a command code for identifying the type of the packet.

The common data pointer 42 acquires, from the packet list processing section 22, a leading address of a block in which is stored the common data included in the packet designated by the packet list processing section 22. Furthermore, the common data pointer 42 acquires from the lower-level sequencer 28 an offset position within the block. The common data pointer 42 provides the common data storage section 40 with the address determined based on the leading address and the offset position, e.g. an address that is the sum of the leading address and the offset position, and supplies the data processing section 32 with the common data stored at this address.

The first and second individual data storage sections 44-1 and 44-2 store individual data that changes for each packet, in the data sequence included in each packet type. The first and second individual data storage sections 44-1 and 44-2 may store actual data transmitted to the device under test 200 or actual data received from the device under test 200, which is included in each packet.

The first individual data storage section 44-1 stores predetermined individual data that is not affected by the test program being executed. The second individual data storage section 44-2 stores individual data that is changed for each test program executed. For example, the second individual data storage section 44-2 receives individual data from the main memory 104, either before testing or during testing as desired.

The first and second individual data pointers 46-1 and 46-2 receive from the packet list processing section 22 the leading address of the block in which is stored the individual data included in the packet designated by the packet list processing section 22. Furthermore, the first and second individual data pointers 46-1 and 46-2 acquire from the lower-level sequencer 28 the offset position in this block. The first and second individual data pointers 46-1 and 46-2 supply the first and second individual data storage sections 44-1 and 44-2 with the address determined based on the leading address and the offset position, e.g. an address that is the sum of the leading address and the offset position, and supply the data processing section 32 with the individual data stored at this address.

The lower-level sequencer 28 reads from the packet command sequence storage section 24 the command sequence of the packet designated by the packet list processing section 22, i.e. the command sequence at the address designated by the packet list processing section 22, and sequentially executes the commands included in the read command sequence. Furthermore, the lower-level sequencer 28 sequentially reads from the packet data sequence storage section 26, according to the command sequence execution, the data sequence of the packet designated by the packet list processing section 22, i.e. the data sequence at the address designated by the packet list processing section 22, and generates the test data pattern used for testing the device under test 200.

The lower-level sequencer 28 may supply the common data pointer 42, the individual data pointer 46-1, and the individual data pointer 46-2 with the offset position indicating the position of the data corresponding to the executed command in the block storing the data sequence included in the packet designated by the packet list processing section 22, for example. In this case, the lower-level sequencer 28 may generate an expected value at the first command and generate the offset position to be a count value that is incremented each time the command being executed changes. The command sequences executed by the lower-level sequencer 28 preferably do not include jump-forward commands or branching commands. As a result, the lower-level sequencer 28 can achieve high-speed processing with a simple configuration.

For each command execution, the lower-level sequencer 28 supplies the data processing section 32 with control data instructing application of a designated process, e.g. a computation or data conversion, to the read individual data or the common data. As a result, the lower-level sequencer 28 can cause a designated data portion in the packet designated by the packet list processing section 22 to be data resulting from a designated process being applied to the read data.

For each command execution, the lower-level sequencer 28 designates which of the common data, the individual data, and the data processed by the data processing section 32 is output by the data processing section 32. Here, the individual data is the predetermined individual data that is not affected by the test program being executed or the individual data that changes for each packet being executed. In other words, for each command execution, the lower-level sequencer 28 designates, for the data processing section 32, that data is to be read and output from one of the common data storage section 40, the first individual data storage section 44-1, the second individual data storage section 44-2, and the register storing the processed data in the data processing section 32.

As a result, the lower-level sequencer 28 can generate the data portion that changes for each packet in the packet designated by the packet list processing section 22, based on the individual data read from the individual data storage section 44. Furthermore, the lower-level sequencer 28 can generate the data portion common to each packet type in the packet designated by the packet list processing section 22, based on the common data read from the common data storage section 40. Yet further, the lower-level sequencer 28 can cause the designated data portion in the packet designated by the packet list processing section 22 to be data resulting from the designated process being applied to the read data.

The transmission-side lower-level sequencer 28 may notify the reception-side lower-level sequencer 28 that a test data sequence of the predesignated packet has been transmitted to the device under test 200, for example. In this way, the transmission-side lower-level sequencer 28 can prevent the judging section 84 from making the pass/fail judgment of the data received by the receiving section 82 until the reception-side lower-level sequencer 28 receives notification from the transmission-side lower-level sequencer 28.

The transmission-side lower-level sequencer 28 may receive notification from the reception-side lower-level sequencer 28 that a data sequence matching the generated test data sequence has been received, and generate the test sequence data of the predesignated packet, for example. In this way, the transmission-side lower-level sequencer 28 can transmit the predesignated packet to the device under test 200 after the prescribed packet is received from the device under test 200.

The data processing section 32 may receive data from the common data storage section 40, the first individual data storage section 44-1, and the second individual data storage section 44-2, perform the process designated by the lower-level sequencer 28 on the received data, and output the result as the data of the test data sequence. Depending on the content of the designation by the lower-level sequencer 28, the data processing section 32 may output the received data as-is, as the test data sequence. The transmitting section 34 transmits the test data sequence output by the data processing section 32 to the device under test 200.

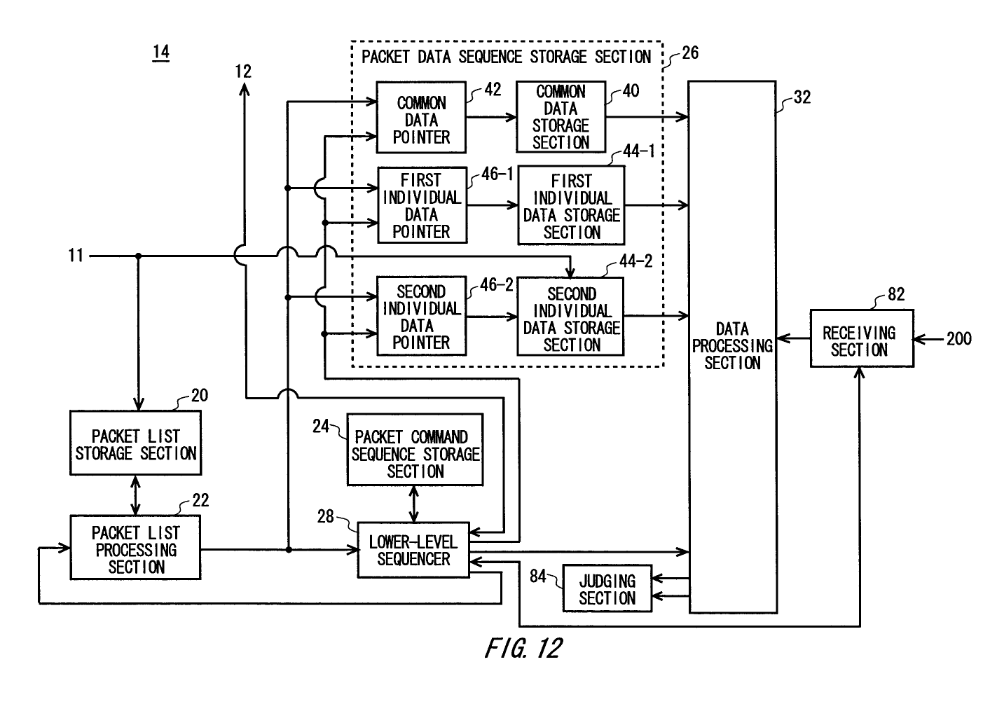

FIG. 12 shows an exemplary configuration of the reception-side block 14. The reception-side block 14 has substantially the same function and configuration as the transmission-side block 12 shown in FIG. 11. Components of the reception-side block 14 that have the same function and configuration as components of the transmission-side block 12 are given the same reference numerals, and further description is omitted.

The reception-side block 14 includes a packet list storage section 20, a packet list processing section 22, a packet command sequence storage section 24, a packet data sequence storage section 26, a lower-level sequencer 28, a data processing section 32, a receiving section 82, and a judging section 84. The receiving section 82 receives the data sequences of reception packets from the device under test 200. The data processing section 32 in the reception-side block 14 receives the data sequence received by the receiving section 82, and outputs the received data sequence together with the generated test data sequence.

The lower-level sequencer 28 in the reception-side block 14 outputs the data sequence of the packet expected to be output from the device under test 200, as the test data sequence. The lower-level sequencer 28 in the reception-side block 14 designates, for the receiving section 82, a strobe timing for acquiring the data value of the signal output from the device under test 200.

The judging section 84 receives, from the data processing section 32, the test data sequence and the data sequence received by the receiving section 82. The judging section 84 judges pass/fail of the communication with the device under test 200, based on the result of a comparison between the data sequence received by the receiving section 82 and the test data sequence. For example, the judging section 84 may include a logic comparing section that makes a comparison to determine whether the test data sequence and the data sequence received by the receiving section 82 match, and a fail memory that records the comparison results.

The lower-level sequencer 28 in the reception-side block 14 communicates with the transmission-side lower-level sequencer 28 of the transmission-side block 12 shown in FIG. 11. As a result, the reception-side lower-level sequencer 28 of the reception-side block 14 can execute command sequences in synchronization with the transmission-side lower-level sequencer 28 of the transmission-side block 12 by performing a handshake with the transmission-side lower-level sequencer 28.

The reception-side lower-level sequencer 28 may notify the transmission-side lower-level sequencer 28 when a data sequence is received that matches the test data sequence generated by the reception-side lower-level sequencer 28. As a result, the transmission-side lower-level sequencer 28 can receive the notification from the reception-side lower-level sequencer 28 that a data sequence matching the generated test data sequence is received, and generate the test data pattern of the predesignated packet.

The reception-side lower-level sequencer 28 may prohibit the judging section 84 from performing the pass/fail judgment of the data sequence received by the receiving section 82 until notification is received from the transmission-side lower-level sequencer 28 that the test data sequence of the predesignated packet has been transmitted to the device under test 200. As a result, the reception-side lower-level sequencer 28 can judge whether the device under test 200 has output a response to the prescribed packet after the prescribed packet has been transmitted to the device under test 200.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention can be used to achieve a debug method and a test apparatus that can identify whether a test pattern is correctly transmitted or received during a handshake.

What is claimed is:

1. A test apparatus that tests a device under test by communicating with the device under test using packets that each include one or more command sequences, the test apparatus comprising:
a transmitting/receiving section that transmits and receives the packets to and from the device under test based on packet sequence information designating an order in which the packets are transmitted and received between the device under test and each pin of the test apparatus; and
a display section that displays information indicating the packets transmitted and received between the device under test and each pin of the test apparatus, arranged in time sequence.

2. The test apparatus according to claim 1, wherein
the display section displays information of each packet transmitted or received in parallel on a time axis set in common for each pin of the test apparatus.

3. The test apparatus according to claim 1, wherein
each packet includes identification information identifying a type of the packet, and
the display section displays information including the identification information of each packet.

4. The test apparatus according to claim 3, further comprising a detecting section that detects the identification information of each packet transmitted to or received from the device under test, wherein
the display section displays information including the identification information detected by the detecting section.

5. The test apparatus according to claim 1, wherein
the display section displays the packets with different appearances, according to the type of the packet.

6. The test apparatus according to claim 1, further comprising a comparing section that compares a data value of a predetermined one of the packets received from the device under test to a predetermined expected value, wherein
the display section displays the packets with different appearances, according to a result of the comparison by the comparing section.

7. The test apparatus according to claim 1, wherein
the display section displays source code of the packet sequence information together with information indicating the packets transmitted or received according to the packet sequence information.

8. The test apparatus according to claim 7, further comprising an editing section that designates a location in the source code of the packet sequence information displayed by the display section and, when editing information for changing content of the location is received, changes the content of the location in the source code of the packet sequence information.

9. The test apparatus according to claim 8, further comprising a packet designating section that, when designation information is received designating a piece of information from among the pieces of information indicating the packets displayed by the display section, displays in the display section the source code of the packet corresponding to the designation information.

10. The test apparatus according to claim 9, wherein
the editing section designates a location in the source code of a packet displayed by the display section and, when editing information for changing content of the location is received, changes the content of the location in the source code of the packet.

11. A debug method for debugging a test apparatus by communicating with a device under test using packets that each include one or more command sequences, wherein
the test apparatus includes a transmitting/receiving section that transmits and receives the packets to and from the device under test based on packet sequence information designating an order in which the packets are transmitted and received between the device under test and each pin of the test apparatus, and the debug method comprises:
displaying information that indicates the packets transmitted and received between the device under test and each pin of the test apparatus, arranged in time sequence.
